(19) United States
(12) Patent Application Publication
(10) Pub. No.: US 2004/0145580 A1
(43) Pub. Date: Jul. 29, 2004

(54) Apparatus and method for reflective display of images on a card

(76) Inventor: Stephen G. Perlman, Palo Alto, CA (US)

Correspondence Address: BURGESS & BEREZNAK LLP, 800 WEST EL CAMINO REAL, SUITE 180, MOUNTAIN VIEW, CA, 94040, US

(21) Appl. No.: 10/353,707

(22) Filed: Jan. 29, 2003

(51) Int. Cl. G09G 5/00

(52) U.S. Cl. 345/204

(57) ABSTRACT

A reflective image display card equipped with an electrical connector to connect to a host computer is disclosed. Executing software code on the host computer allows for the transfer of selected images from the host computer to the reflective image display card using USB protocols. The present invention enables a user to keep an image, such as a simple photograph transmitted from the host computer, for months or years without using a significant amount of power. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### FIELD OF THE INVENTION

The present invention relates generally to flat panel display devices; more particularly, to reflective image display cards and apparatus and methods for transfer of data to such cards.

### BACKGROUND

With the increasing popularity of mobile devices such as personal digital assistants (PDAs), digital cameras, advanced pagers, cell phones, and other wireless Internet devices, research has been directed to improving the quality of flat panel displays. These mobile applications all share the need for low power and paper-like flat panel displays that can provide vivid, full-colored images in any lighting condition. Liquid crystal displays (LCDs) and plasma display panels (PDPs) are two typical flat panel display devices that are available on the market. LCDs have disadvantages in that they have a narrow view angle, a slow response speed, and the fabrication process is complicated. While PDPs may be easier to fabricate, they have low discharge and luminescence efficiencies. In addition, both LCDs and PCPs use power to refresh the image displayed on the screen, and this constant refreshing uses up the battery. Mobile devices therefore often come equipped with ways to turn off the display when the device is idle for a while.

Recently, developments in display technology have allowed for flat panel displays using effectively zero power consumption when holding a steady image. Some of these new displays use a micro light modulator having Micro Electromechanical Systems (MEMS), an extra hyperfine machining technology for displaying a picture. In MEMS, an image is created by modulation of an external light source by reflection from a surface that contains moveable reflective or diffractive surfaces. By way of example, Iridigm Display Corporation of San Francisco, Calif. has developed a reflective, direct-view, color flat panel display based on MEMS technology. The display format is 240×160×RGB pixels, which provides a high resolution image with ultra low power consumption. Flat panel display cards that utilize micro light modulation technology are also described in U.S. patent application Ser. Nos. 20010043385 and 20020047564.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 is a perspective view illustrating the connection between a host computer and an image display card in accordance with one embodiment of the present invention.

FIG. 2 is a perspective view illustrating the connection between a host computer and an image display card in accordance with another embodiment of the present invention.

FIG. 3 is a circuit block diagram of a system for transfer of image data between a reflective display card and a host computer according to one embodiment of the present invention.

FIG. 4 is circuit block diagram of a reflective image display card in accordance with one embodiment of the present invention.

### DETAILED DESCRIPTION

An improved reflective image display card that provides high resolution image with ultra low power consumption is disclosed. Also disclosed are a connector apparatus and a method for transferring image data to a mobile card for storage and display thereon. In the following description numerous specific details are set forth, such as circuit elements, connector types, data formats, and the like, in order to provide a thorough understanding of the present invention. However, persons having ordinary skill in the computer arts will appreciate that these specific details may not be needed to practice the present invention.

According to an embodiment of the present invention, an apparatus that includes a universal serial bus (USB) connector or similar type of electrical connector is provided to facilitate the transfer of image data from host computer to a reflective image display card. Alternatively, the reflective image display card may be provided with an edge interface for connective insertion via a slot or port of a host device, such as a computer. Software executed on the host computer enable a user to load one or more images stored on the computer out to the reflective image display card via the connector apparatus. The present invention enables a user to store a high-resolution image, such as a photograph, on a portable, flat color display card for months or years without the need for power recharging.

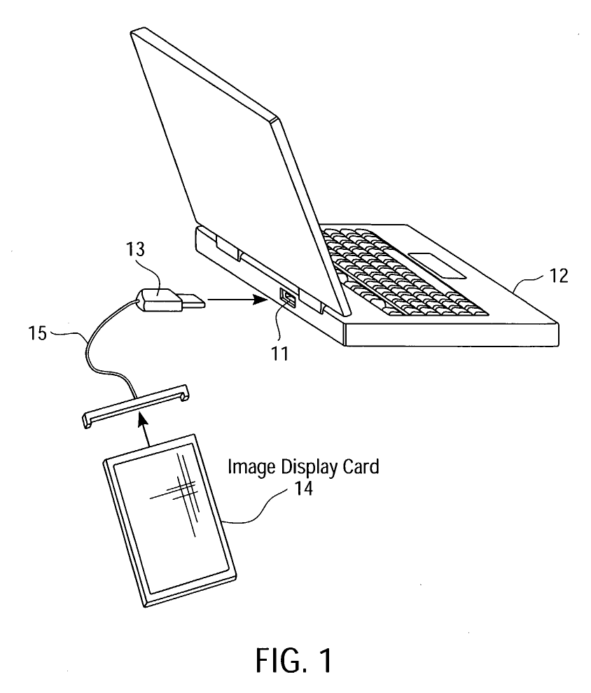

FIG. 1 illustrates the connection between a host computer 12 and a portable image display card 14 in accordance with one embodiment of the present invention. In the embodiment shown, card 14 is a very thin, pocket-sized card that may easily fit within a wallet, for example. A standard USB port 11 located on a rear side of host computer 12 accepts a compatible mini USB plug 13 coupled to a portable image display card 14. Other types of plugs or port connections (e.g., serial, parallel, infrared, etc.) may also be utilized. In this particular embodiment, host computer 12 comprises a laptop personal computer, but other types of computers (e.g., desktops, workstations) and microprocessor controlled devices may also be used as the host computing device. For example, an image repository device that includes a processor coupled to a random-access memory (RAM) or read-only memory (ROM) having a compatible connector port may alternatively be used as a host computing device.

Host computer 12 may include one or more processors coupled to one or more forms of computer-readable memory/media such as electronic memory (RAM, ROM, non-volatile memory), magnetic storage media, optical storage media, or some other type of data storage. Programs are stored in memory from where they are executed by the computer's processor(s). For example, such programs include an operating system program and an application program to allow a user to select a particular image for transfer to image display card 14. The USB port 11 is supported by the hardware driver devices and the operating system of host computer 12. To communicate with image display card 14, the application program running on host computer 12 may make high-level calls to system services provided by the operating system.

According to one embodiment of the present invention, image display card 14 includes a micro light modulation flat-panel display which comprises a pixel array or matrix of movable electrodes or other elements (chemical, physical, or electronic) in accordance with known technologies (such as MEMS) for producing a reflective or iridescent image. Alternative embodiments may utilize other types of low-power reflective or zero-power reflective display panels or sheets. For example, E Ink Corporation of Cambridge, Massachusetts manufactures display products that utilize microcapsules containing positively charged white particles and negatively charged black particles suspended in a clear fluid. These microcapsules are printed onto a sheet of plastic film that is laminated to a layer of circuitry that forms a pattern of pixels that can then be controlled by a display driver to create a front viewing plane of a display module. The term “display panel”, as used in the context of the present application, is therefore intended to encompass a display panel or sheet manufactured in accordance with any of the different technologies available for producing a low-power or zero-power display image.

With continuing reference to FIG. 1, USB plug 13 is shown electrically coupled to card 14 via a wire cable 15 connected to an edge connector 16. Edge connector 16 includes terminals that provided mated connection with corresponding terminals located along an edge of card 14. Image data is transferred between host computer 12 and display card 14 via the interface connection provided by USB plug 13, cable 15, and edge connector 16.

An electrical connection is established between host computer 12 and image display card 14 by attaching edge connector 16 to card 14 and plugging USB plug 13 into port 11. Communications may take place between host computer 12 and image display card 14 using conventional USB protocols that are well known in the art. In one example, host computer 12 may contain code implemented in software such as JAVA™, Perl, C++, etc., stored on a computer-readable memory/media that allows the host computer 12 to transmit an image stored on the host computer 12 directly to the reflective image display card 14 using the USB protocols.

When an electrical connection is established between image display card 14 and host computer 12 through port 11, image display card 14 receives a supply voltage from the power supply of the host computer 12. The voltage potential provided through this connection is used to activate circuitry included in card 14. This circuitry (described in more detail shortly) allows the individual pixel or matrix elements of the display panel to move and thus change the state of the optically reflective display in accordance with the image data. By way of example, the image data transferred to image display card 14 from host computer 12 may comprise a bit map of a digital photograph.

Because the matrix or array of elements that comprises image display card 14 creates an optical image by reflectively modulating an external light source off a surface that contains moveable reflective or diffractive surfaces, virtually no power is required to maintain the image state after plug 13 is removed from port 11. In other words, the transferred image or picture persists on the surface of image display card 14. Display card 14 will retain this image for months or even years, without refreshment, until a new image is transferred to card 14 from host device 12. In this manner, a user may store the picture transferred to the reflective image display card 14 from the host computer 12 for extended periods of time without externally-supplied power.

In an alternative embodiment, portable image display card 14 is manufactured with an integral connector (e.g., USB plug) along one edge of the card, such that the card may be directly plugged into a compatibly mated connector port of host computer 12.

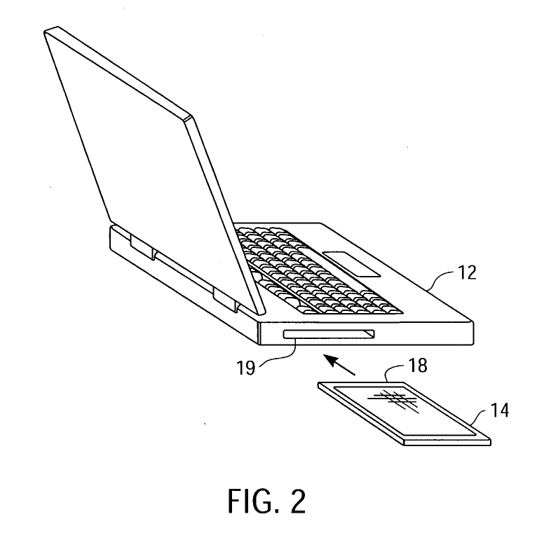

Referring now to FIG. 2, connection between a host computer 12 and a portable image display card 14 is shown according to another embodiment of the present invention. In this embodiment, host computer 12 is configured with a slot 19 that is adapted to receive image display card 14. Display card 14 is configured with terminals (not shown) disposed along an insertion edge 18 of card 14. These terminals provide electrical connection with corresponding interface terminals located within slot 19. For instance, in a specific implementation card 14 may be manufactured to have a USB connector integral with a side surface of the substrate of the reflective image display card 14 to facilitate electrical connection between image display card 14 and host computer 12. Slot 19 may be disposed at any location of the external housing of host computer 12 that provides for convenient insertion of display card 14.

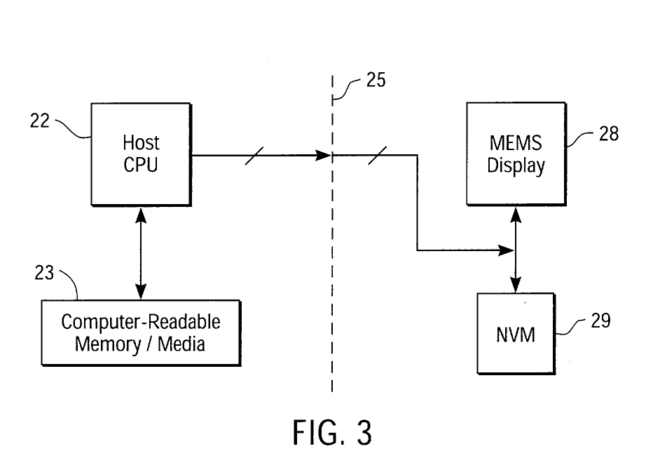

Referring now to FIG. 3 there is shown a circuit block diagram of a system for transfer of image data between a host device and an image display card in accordance with one embodiment of the present invention. In FIG. 3, the basic electronic components of the host device (e.g., host computer) appear to the left of dashed line 25, which denotes the connective interface (e.g., USB connection) between the host device and the image display card. The basic components of the display card are shown to the right of interface 25.

As can be seen, host computing device 12 includes a host central processing unit (CPU) 22 coupled to a computer-readable memory or media storage device 23. CPU 22 is also coupled to interface 25, for example, via a connection port or slot as shown in FIGS. 1 & 2. Execution by CPU 22 of software code stored in memory/media 23 causes the host computer 12 to transfer image data to the image display card via interface 25. The image data may be stored in memory/media 23 or in another storage location associated with the host computing device. The image data provided by host CPU 22 is received by the image display card where it may be loaded in display panel 28 and stored in non-volatile (e.g., “flash”) memory 29.

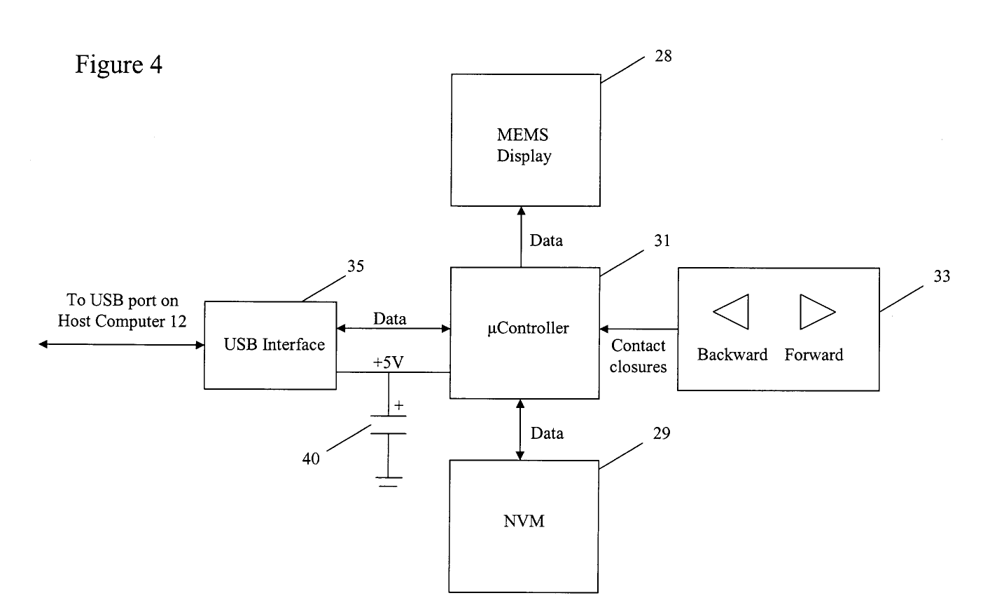

FIG. 4 is detailed circuit block diagram of an image display card 14 in accordance with one embodiment of the present invention. The image display card includes USB connection port 35 coupled to a display panel 28. An electrolytic capacitor 40 is coupled to the power supply line of USB port 35. Capacitor 40 stores charge used to power the electronic components of the image display card during data transfer, for example. When the USB port 35 is connected to the host computer, capacitor 40 receives the charge from the power supply of the host computer through the standard USB interface power supply pin. Alternatively, either a primary or rechargeable battery can be used in place of capacitor 40, e.g., if more power storage capacity is needed.

In FIG. 4 a microcontroller 31 is shown coupled to USB port 35 and to non-volatile, flash memory 29 that is utilized to hold image display data. Alternatively, microcontroller 31 may be embedded with flash memory. Microcontroller 31 may also include a RAM for storing data, and/or a ROM to store instructions and code received from the host computer device. It is appreciated that microcontroller 31 may comprise any one of a variety of microprocessor or microcomputer chips.

When image display card 14 is connected to host computing device 12 and power is available, the microcontroller 31 is operative to update non-volatile memory 29 with images (and potentially new software) from host computing device 12. Microcontroller 31 can also display messages and graphics on display panel 28 indicative of status. In one embodiment, when image display card 14 is disconnected from host computing device 12, microcontroller 12 is normally in a zero-power quiescent state; it may transition out of the zero-power quiescent state (“wake-up”) as necessary to respond to specific user requests. In this way, microcontroller 12 minimizes power consumption from capacitor 40.

The architecture of FIG. 4 is useful to receive and store data associated with multiple images for display on display panel 28. Individual images may be selected via a simple user interface (not shown) coupled to microcontroller 31. For example, a user may press forward or backward buttons 33 on a side surface of the display card to cycle through a series of images stored in non-volatile memory 29. Other implementations may utilize only a single button. Software for microcontroller 31 may optionally be included on the display card (stored either in ROM on the microcontroller or in NVM 29) to facilitate the storage and sequential display of multiple images transferred to the image display card from the host computer. When one of the buttons 33 is pressed, microcontroller 31 transitions out of its quiescent state (i.e., is “awakened”), and responds by transferring a new image from NVM 29 to display panel 28. Either a subsequent image or a previous image in a sequence of images is transferred to display panel 28 depending on whether “forward” or “backward” is pressed. Once the image data has been loaded into the display panel 28, microcontroller 31 may transition back to the zero-power quiescent state.

It should be understood that although the present invention has been described in conjunction with specific embodiments, numerous modifications and alterations are well within the scope of the present invention. Accordingly, the specification and drawings are to be regarded in an illustrative rather than a restrictive sense.

I claim:

1. A method of operation between a host computer and a card having a display panel for reflective display of an image, comprising:
connecting the card to the host computer;
receiving, by the card, a supply voltage from the host computer to activate elements of a reflective display panel of the card;
transferring image data stored on the host computer to the card to realize the image on the reflective display panel.

2. The method of claim 1 further comprising:
disconnecting the card from the host computer, with the image being retained on the reflective display panel of the card.

3. The method of claim 1 wherein connecting the card to the host computer comprises plugging a universal serial bus (USB) connector coupled to the card into a USB port of the host computer.

4. The method of claim 1 wherein connecting the card to the host computer comprises inserting an edge of the card into a slot of the host computer, the slot being adapted to receive the card.

5. The method of claim 1 further comprising:
executing code in the host computer to cause the host computer to transfer the image data to the card.

6. The method of claim 1 further comprising:
storing the image data in a non-volatile memory of the card.

7. A portable image display card, comprising:
a display panel that creates an optical image by reflectively modulating an external light source from a surface that includes an array of surface elements;
a connection port;
a non-volatile memory to store image data;
a microcontroller to control transfer of the image data provided at the connection port the non-volatile memory, and to control the surface elements of the display panel in accordance with the image data.

8. The portable image display card of claim 7 wherein the surface elements comprise reflective surfaces.

9. The portable image display card of claim 7 wherein the surface elements comprise diffractive surfaces.

10. The portable image display card of claim 7 wherein the non-volatile memory has a storage capacity to hold multiple optical images.

11. The portable image display card of claim 7 wherein the non-volatile memory comprises a flash memory embedded within the microcontroller.

12. A portable image display card, comprising:
a display panel that creates an optical image by reflectively modulating an external light source from a surface that includes an array of surface elements;
a connection port;
a non-volatile memory to store image data;
a microcontroller to control transfer of the image data provided at the connection port the non-volatile memory, and to control the surface elements of the display panel in accordance with the image data; and
electronics coupled to the microcontroller to sequential display of multiple optical images stored in the non-volatile memory.

13. The portable image display card of claim 12 wherein the surface elements comprise reflective surfaces.

14. The portable image display card of claim 12 wherein the surface elements comprise diffractive surfaces.

15. A portable image display card, comprising:
a display panel that creates an optical image by reflectively modulating an external light source from a surface that includes an array of surface elements;
a port;
a non-volatile memory to store image data;
a microcontroller to control transfer of the image data provided at the port the non-volatile memory, and to control the surface elements of the display panel in accordance with the image data; and
a capacitor to hold a supply voltage provided at the port, the supply voltage powering the microcontroller and the non-volatile memory.

16. The portable image display card of claim 15 further comprising means for sequentially displaying multiple optical images stored in the non-volatile memory.

17. An electronic system for portable display of images, comprising:
a portable card having a display panel that creates an optical image by reflectively modulating an external light source from a surface that includes an array of surface elements;
a connector for connecting the image display card to the host computer for the transferring of image data from the host computer to the image display card; and
a host computing device that stores image data and executes a program to transfer the image data to the portable card, the image date changing a state of the array of surface elements to create the optical image on the display panel; and
a connector for electrically connecting the portable card to the host computing device.

18. The portable image display card of claim 17 wherein the surface elements comprise reflective surfaces.

19. The portable image display card of claim 17 wherein the surface elements comprise diffractive surfaces.

20. The portable image display card of claim 17 wherein the connector comprises a universal serial bus (USB) connector.

21. The portable image display card of claim 20 wherein the USB connector is integral with a portion of the image display card.

22. The portable image display card of claim 17 wherein the program is stored in a computer readable memory/media of the host computer.

23. An electronic system for portable display of images, comprising:
a portable card that includes:
a display panel that creates an optical image by reflectively modulating an external light source from a surface that includes an array of surface elements;
a connection port;
a non-volatile memory to store image data;
a microcontroller to control transfer of the image data provided at the connection port the non-volatile memory, and to control the surface elements of the display panel in accordance with the image data; and
means for sequential display of multiple optical images stored in the non-volatile memory;
a host computing device that stores image data and executes a program to transfer the image data to the portable card, the image date changing a state of the array of surface elements to create the optical image on the display panel; and
connector means for electrically coupling the connection port to the host computing device to effectuate transfer of image data from the host computing device to the portable card.

24. The portable image display card of claim 23 wherein the connector means comprises a universal serial bus (USB) connector.

25. The portable image display card of claim 24 wherein the USB connector is integral with a portion of the image display card.

26. The portable image display card of claim 23 wherein the program is stored in a computer readable memory/media of the host computer.

27. A portable image display card, comprising:
a zero-power display panel that creates an image by reflectively modulating an external light source from a front viewing plane that includes an array of elements;
a connection port;
a non-volatile memory to store image data;
means for transferring the image data provided at the connection port to the non-volatile memory, and for controlling the surface elements of the display panel in accordance with the image data.

28. The portable image display card of claim 27 wherein the array of elements comprise microcapsules containing charged particles suspended in a fluid.

29. The portable image display card of claim 27 wherein the array of elements comprise movable reflective surfaces.

30. The portable image display card of claim 27 wherein the non-volatile memory has a storage capacity to hold multiple optical images.

31. The portable image display card of claim 27 wherein the means comprises a microcontroller.

32. A portable image display card, comprising:
an ultra low power display panel that creates an image by reflectively modulating an external light source from a front viewing plane that includes an array of elements;
a connection port;
a non-volatile memory to store image data;
a microcontroller that transfers the image data provided at the connection port to the non-volatile memory, the microcontroller controlling the surface elements of the ultra low power display panel in accordance with the image data.

33. The portable image display card of claim 32 wherein the array of elements comprise microcapsules containing charged particles suspended in a fluid.

34. The portable image display card of claim 32 wherein the array of elements comprise movable surfaces.

35. The portable image display card of claim 32 wherein the means comprises a microcontroller.

36. The portable image display card of claim 32 wherein the non-volatile memory has a storage capacity to hold multiple optical images.

37. The portable image display card of claim 36 further comprising means for sequentially transferring each of the multiple optical images to the ultra low power display panel for display thereon.
